(19) United States
(12) Patent Application Publication
(10) Pub. No.: US 2024/0168826 A1
(43) Pub. Date: May 23, 2024

(54) METHOD OF ANALYZING CHANGE IN API IN CLOUD

(71) Applicant: ASTRON SECURITY INC., seoul (KR)

(72) Inventor: Keun Seok CHO, Anyang-si (KR)

(21) Appl. No.: 17/994,735

(22) Filed: Nov. 28, 2022

(30) Foreign Application Priority Data
Nov. 18, 2022 (KR) 10-2022-0155863

(51) Int. Cl. G06F 9/54

(52) U.S. Cl. CPC G06F 9/542; G06F 9/547

(57) ABSTRACT

Disclosed is a method of analyzing a change in an API in a cloud by a server. The server includes: a document collecting module, an event collecting module and a controller. The method includes identifying a change point of the API and reflecting a content of the change point of the API in the database.

### BACKGROUND OF INVENTION

### Field of the Invention

The present disclosure relates to a technology for analyzing changes in a cloud API, and more particularly, to a system for detecting and applying change points to all event information received through a cloud API in a cloud computing environment.

### Related Art

Recently, a Software as a Service (SaaS) has become a common computing service due to the development and spread of cloud technologies. Accordingly, it is more and more important to identify APIs provided by various cloud providers for cloud functions, management, and improvement.

However, it is difficult to quickly detect a created and deleted cloud API in real time due to different policies for each cloud, and it is difficult to smoothly reflect various APIs. In addition, if a change point is not applied to a solution, incorrect data may cause the solution to malfunction and cause great damage to the company depending on the importance of the cloud API.

Therefore, there are increasing demands for a method to more effectively receive real-time API change point in a cloud.

### RELATED DOCUMENT

### Patent Document

(Patent Document 1) Korea Patent Application Publication No. 10-2022-0112995 (published on Aug. 12, 2022)

### SUMMARY

The present disclosure provides a method of analyzing a change point of an API in a cloud so as to easily identify and efficiently manage a change the API in the cloud.

The present disclosure also provides a method of analyzing a change point of an API in a cloud, which provides a notification in response to importance of an API change point in a cloud satisfying a notification threshold, so that a server manager can easily manage a server.

In an aspect, there is provided a method of analyzing a change in an API in a cloud by a server.

The server includes: a document collecting module configured to collect a document via a network; an event collecting module configured to collect information on a user's events; a database configured to store information on APIs; and a controller configured to control the document collecting module and the event collecting module. The method includes: collecting, by the document collecting module, a 1a document at a first point in time via the network, wherein the 1a document is a document about a first API collected at the first point in time; collecting, by the document collecting module, a 1b document at a second point in time via the network, wherein the 1b document is a document about a first API collected at the second point in time; determining, by the controller, whether any change has been made regarding the first API by comparing the 1a document and the 1b document; in response to a determination that any change has been made regarding the first API, identifying a change point of the first AP by the controller; reflecting, by the controller, information on the change point of the first API in the database; collecting, by the event collecting module, a 1a event at a third point in time, wherein the 1a event is an event about a second API collected at the third point in time; collecting, by the event collecting module, a 1b event at a fourth point in time, wherein the 1b event is an event about the second API collected at the fourth point in time; determining, by the controller, whether any change has been made regarding the second API by comparing the 1a event and the 1b event; in response to a determination that any change has been made regarding the second API, identifying a change point of the second API by the controller; and reflecting, by the controller, a content of the change point of the second API in the database.

The method of analyzing a change in an API in a cloud may be provided as a Software-as-a-Service (SAAS) method.

The identifying of the change point of the second API may include: collecting, by the document collecting module, a second document about the second API; and identifying, by the controller, the change point of the second API based on the second document.

In the identifying of the change point of the second API, the controller may compare the 1a event and the 1b event to identify the change point of the second API.

The method may further include: collecting, by the event collecting module, a second event, wherein the second event is an event about a third API; determining, by the controller, that there is no information on the third API in the database; searching, by the document collecting module, for a third document about the third API via the network; collecting, by the document collecting module, the third document via the network; and generating, by the controller, an item of the third API in the database and reflecting, by the controller, a content of the third API based on the third document.

The method may further include: collecting, by the document collecting module, information on a third document about a third API; determining, by the controller, that there is no information on the third API in the database; searching, by the document collecting module, for a third document about the third API via the network; collecting, by the document collecting module, the third document via the network; and generating, by the controller, an item of the third API in the database and reflecting, by the controller, a content of the third API based on the third document.

The method may further include: determining, by the controller, importance of any one of a change point of the first API and a change point of the second API; determining, by the controller, whether the importance satisfies a notification threshold; and providing, by the controller, a notification of any one of the change point of the first API and the change point of the second API to a manager terminal.

The database may store a plurality of classification groups in which a plurality of APIs are classified by a predetermined criteria, and the method may further include determining, by the controller, at least one of a cycle and a time interval between the first point in time and the second point in time based on a classification group to which the first API belongs among the plurality of classification groups.

In another aspect, there is provided a method of analyzing a change in an API in a cloud, and there are included a memory: a processor connected to the memory and configured to execute instructions contained in the memory; a document collecting module configured to collect documents via a network; an event collecting module configured to collect information on a user's events; a database configured to store information on APIs; and a controller configured to control the document collecting module and the event collecting module. The method includes: collecting, by the document collecting module, a 1a document at a first point in time via the network, wherein the 1a document is a document about a first API collected at the first point in time; collecting, by the document collecting module, a 1b document at a second point in time via the network, wherein the 1b document is a document about a first API collected at the second point in time; determining, by the controller, whether any change has been made regarding the first API by comparing the 1a document and the 1b document; in response to a determination that any change has been made regarding the first API, identifying a change point of the first AP by the controller; reflecting, by the controller, information on the change point of the first API in the database; collecting, by the event collecting module, a 1a event at a third point in time, wherein the 1a event is an event about a second API collected at the third point in time; collecting, by the event collecting module, a 1b event at a fourth point in time, wherein the 1b event is an event about the second API collected at the fourth point in time; determining, by the controller, whether any change has been made regarding the second API by comparing the 1a event and the 1b event; in response to a determination that any change has been made regarding the second API, identifying a change point of the second API by the controller; and reflecting, by the controller, a content of the change point of the second API in the database.

### BRIEF DESCRIPTION OF THE DRAWINGS

FIG. 1 is a diagram illustrating an example of a network environment according to an embodiment of the present disclosure.

FIG. 2 is a diagram illustrating a component of a change point analysis server according to an embodiment of the present disclosure.

FIG. 3 is a flowchart of an operation of a document collecting module according to an embodiment of the present disclosure.

FIG. 4 is a flowchart of an operation of an event collecting module according to an embodiment of the present disclosure.

FIG. 5 is a flowchart illustrating a method for determining a change point when a controller compares one event with another event to determine whether an API has changed according to an embodiment of the present disclosure.

FIG. 6 is a flowchart illustrating how to detect creation of an API according to an embodiment of the present disclosure.

FIG. 7 is an exemplary screen for explaining a method for a controller to compare documents provided from a document server according to an embodiment of the present disclosure.

FIG. 8 is an exemplary screen for explaining a method in which a controller compares events collected by an event collecting module according to an embodiment of the present disclosure.

### DESCRIPTION OF EXEMPLARY EMBODIMENTS

Hereinafter, description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In present specification, steps described can be performed regardless of the listed order, except for a case where they must be performed in the listed order due to a special causal relationship.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described with reference to the accompanying

### DRAWINGS

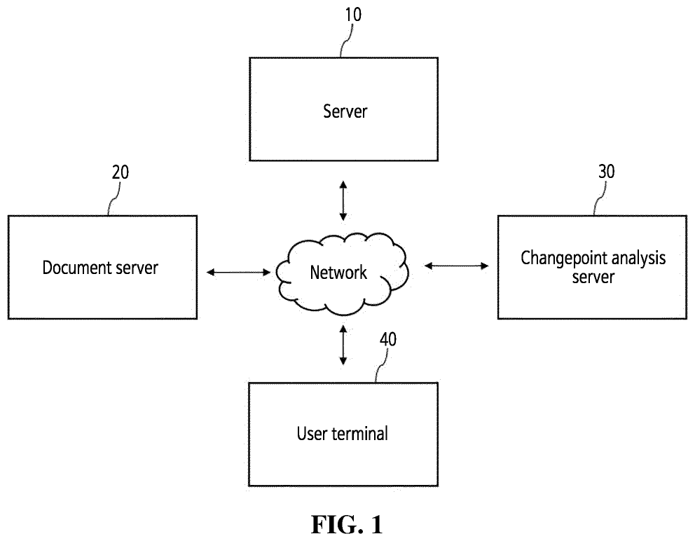

FIG. 1 is a diagram illustrating an example of a network environment according to an embodiment of the present disclosure.

A network environment according to an embodiment of the present disclosure shown in FIG. 1 may include a server 10, a document server 20, a change point analysis server 30, and a user terminal 40.

The server 10 refers to a device that executes an application programming interface (API) according to a predetermined rule or upon a user's request. When the API is executed in the server 10, an event corresponding to the API is created. Event information may include an event name of an executed API, an execution time of the API, an execution entity of the API, and a response syntax of the event. Here, the response syntax means grammar of information generated by the server upon the execution of the API. The server 10 may provide this response syntax to the user terminal.

The server 10 may include an event recorder that stores information on an API execution result. The event recorder may store, as the form of a database, event information corresponding to the API executed by the corresponding server. When the corresponding server is, for example, Amazon Web Services (AWS), the event recorder may be referred to as CloudTrail.

The document server 20 refers to a server that stores a document about an API. Here, the document about the API may be document information describing the name, definition, function of the API, the form of a request syntax, the description of parameters generated or provided upon execution of the API, and the form of a response syntax. For example, an output format of an API may be JSON, YAML, YAML stream, Text, Table, CSV, and the like.

The document about the API may be provided in the form of a webpage by a document server or in the form of a downloadable document. The document about the API may be provided so as to be classified and searched by API name or event name, or may be provided as a list. For example, when a statement output by calling the AWS CloudTrail's LookupEvents API is “cloudtrail:LookupEvents with an explicit deny”, it may be found that an associated Identity and Access Management (IAM) policy is incorrect, and when the output statement is “cloudtrail:LookupEvents because no identity-based policy allows”, it may be found that an error is caused by the identity-policy does not allowing an API operation.

The document server 20 may be created and managed by an entity identical to or associated with an entity for the server 10 that executes the API related to a provided document. Thus, the document server 20 may selectively store documents of APIs executable in the related server 10. For example, when the server 10 is an AWS server, the document server 20 may be a server that provides API Reference items of AWS Documentation. Here, the associated entity that creates and manages the document server may be considered to be a cloud operator including Amazon, Google, Microsoft, Oracle, Naver, and the like which operate cloud computing services.

The change point analysis server 30 may be an entity that performs a method of analyzing a change in an API according to the present disclosure. The change point analysis server 30 may collect event information from an event recorder of the server 10. The change point analysis server 30 may collect documents about the API from the document server 20. Based on the collected event information and documents, the change point analysis server 30 may determine whether any change has been made regarding an API and whether any API is newly created. Thereafter, the change point analysis server 30 stores and manages a API change point and new API creation information in a database.

Here, the change point analysis server 30 may be considered to be Software-as-a-Service (SaaS) that provides cloud applications, IT infrastructure, and platform, and the like through an Internet browser to provide an API change service to a user terminal.

The user terminal 40 refers to a terminal that receives a service for analyzing a change in API provided by the change point analysis server 30. In addition, the user terminal 40 may call an API by performing communication with the server 10 according to a predetermined rule or upon a user's request. A result of the API executed by the server 10 by the call of the user terminal 40 may be stored in an event recorder of the server 10.

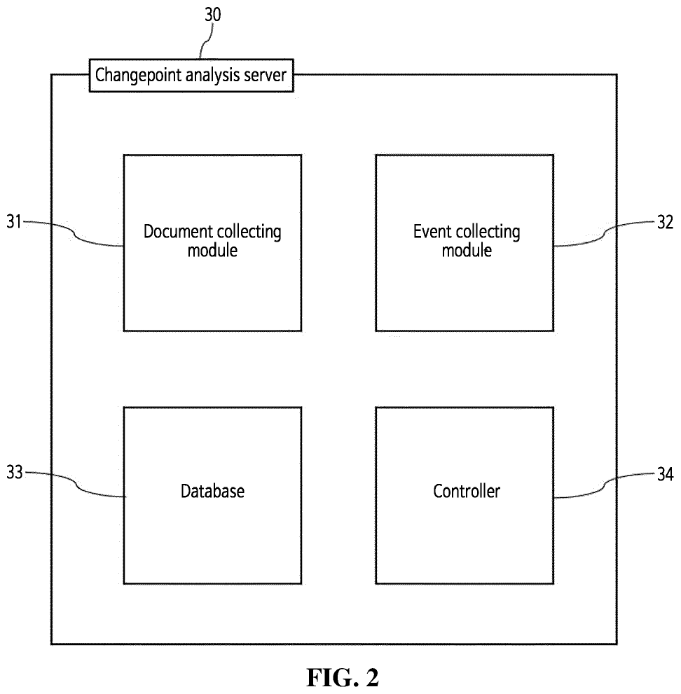

FIG. 2 is a diagram illustrating a component of a change point analysis server according to an embodiment of the present disclosure.

The change point analysis server 30 according to an embodiment of the present disclosure shown in FIG. 2 may include a document collecting module 31, an event collecting module 32, a database 33, and a controller 34.

The document collecting module 31 collects documents about APIs from the document server 20. The document collecting module 31 may collect the same documents at different point in times. Here, the different point in times may be determined by a predetermined cycle or time interval. The predetermined cycle or time interval may be determined according to the importance of an API corresponding to a document, the frequency of use of the API, and a situation of the document server 20.

The event collecting module 32 may access the event recorder, in which information on a result of an API's being executed in the server 10 is stored in the form of a database, to collect event information corresponding to the executed API at a predetermined cycle, at a predetermined time interval, or in real time. Here, collecting event information may be determined by reflecting a request speed of an event recorder of a corresponding server in order to prevent a traffic or data bottleneck error. In addition, inquiry request speed information may also be received from CloudTrail. For example, if an event recorder is the CloudTrail in AWS, an inquiry request speed may be limited to two times per second or less per region for each account, and it may take up to 15 minutes for a result to be provided through the CloudTrail. Thus, a time interval for collecting APIs from the CloudTrail may be determined within a range that satisfies limiting conditions.

The database 33 may store information on APIs executed in the server 10. Information on such an API may be generated based on a document about an API collected by the document collecting module 31 and API event information collected by the event collecting module 32. In addition, when a change in an API or new API creation is confirmed, the database 33 may change pre-stored API information or may newly create API information.

The database 33 may store information on a plurality of APIs. The plurality of APIs may be classified into a plurality of classification groups by a predetermined criteria. The plurality of classification groups may be classified according to the importance of each API, the frequency of use of each API, a function of each API, an authority required when each API is executed, and the like. A cycle and time interval between the first and second points in time and between the third and fourth points in time, which will be described later, may be determined according to the plurality of classification groups.

The controller 34 may control collection and comparison of information in association with the document collecting module 31, the event collecting module 32, and the database 33. The controller 34 may analyze the document about the API by the document collecting module 31 and the API event information collected by the event collecting module 32 to determine whether a change has been made regarding an API, whether a new API has been created, and account activity. In addition, if a change in an API and creation of a new API are confirmed, the controller 34 may perform a control to reflect information on such change point and new creation in the database 33.

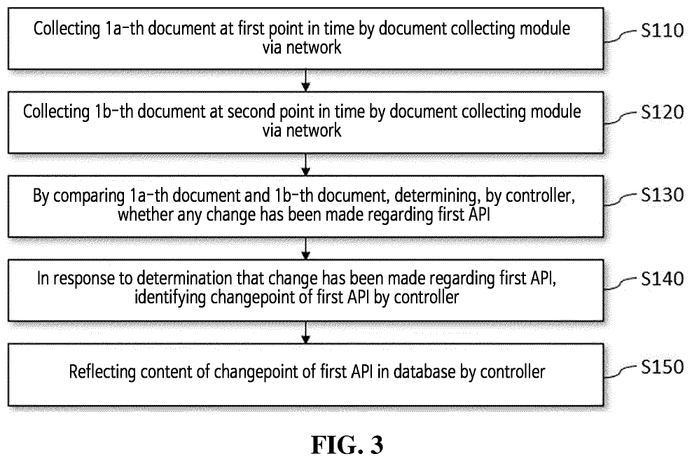

FIG. 3 is a flowchart of an operation of a document collecting module according to an embodiment of the present disclosure.

In operation S110, the document collecting module 31 may access the document server via a network to collect a 1a document at a first point in time.

The document collecting module 31 accesses the document server 20 according to a predetermined rule or a predetermined cycle to collect a document about an API. For example, the document collecting module 31 accesses the document server 20 to collect a document about an API every 6 hours a day, at a predetermined point in time, or upon a request from a user.

Here, the 1a document is a document about a first API collected by the document collecting module 31 at the first point in time.

In the present disclosure, terms such as a first point in time, a second point in time, a third point in time, and a fourth point in time are terms used to describe specific points in time, and do not have a precedence relationship determined by the order in which they are listed.

In some cases, a time interval between points in time and a cycle may be determined based on importance of each API, the frequency of use of each API, a function of each API, and an authority required to execute each API.

In operation S120, the document collecting module 31 may collect a 1b document at a second point in time via the network.

Here, the second point in time refers to a point in time different from the first point in time. The second point in time may be a point in time subsequent to the first point in time. Here, the 1b document is a document about the first API collected by the document collecting module 31 at the second point in time.

In operation S130, the controller 34 determines whether any change has been made regarding the first API by comparing the 1a document and the 1b document.

The document server 20 may change the document about the first API, stored in the document server 20, for various reasons. If this change is made between the first point in time and the second point in time, the 1a document and the 1b document may have different information.

Here, the various reasons may be changes in API name, function, and syntax. In addition, in some cases, even if there is no change to an API itself, a phrase describing the API may be changed.

A change point between the 1a document and the 1b document may be detected using a Natural Language Processing (NLP)-based artificial intelligence model for data collected through the document server 20. Here, the NLP-based artificial intelligence model may include sentence length comparison, morphological analysis, and table parsing functions.

In operation S140, the controller 34 may identify a change point of the first API when it is determined that any change has been made regarding the first API in operation S130.

Specifically, the controller 34 may identify a content and type of the change point of the first API. For example, the controller 34 may identify information on a word change, a sentence change, and a paragraph change in the document, and syntax information of a change.

In operation S150, the controller 34 reflects the content of the change point of the first API in the database 33.

When the change point of the API and the syntax of the change are identified in operation S140, the controller 34 may perform a control to reflect the change point in the description of the first API in the database 33.

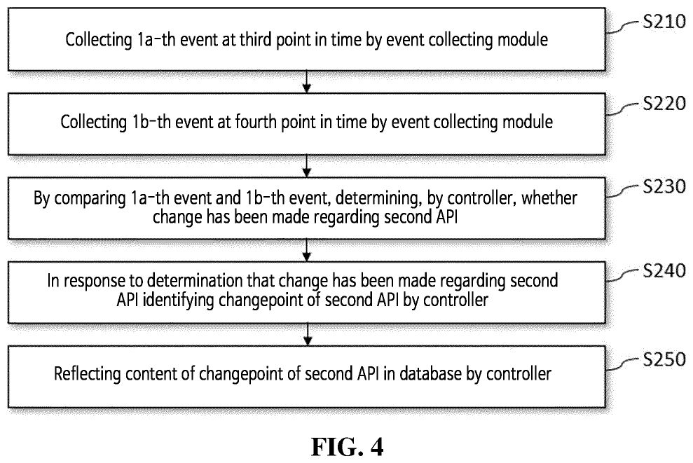

FIG. 4 is a flowchart illustrating operations of the event collecting module 32 according to an embodiment of the present disclosure.

In operation S210, the event collecting module 32 collects a 1a event at a third point in time. The 1a event is an event for the second API collected by the event collecting module 32 at a first point in time. Here, the third point in time may include a point in time identical to the first point in time.

An event for the second API collected by the event collecting module 32 may include a name of an executed API, an execution time of the API, an execution entity of the API, a location of data, a user, an operation to be performed, and a response syntax.

In operation S220, the event collecting module 32 collects a 1b event at a fourth point in time. Here, the 1a event and the 1b event are events for the same second API, which have taken place at different points in times.

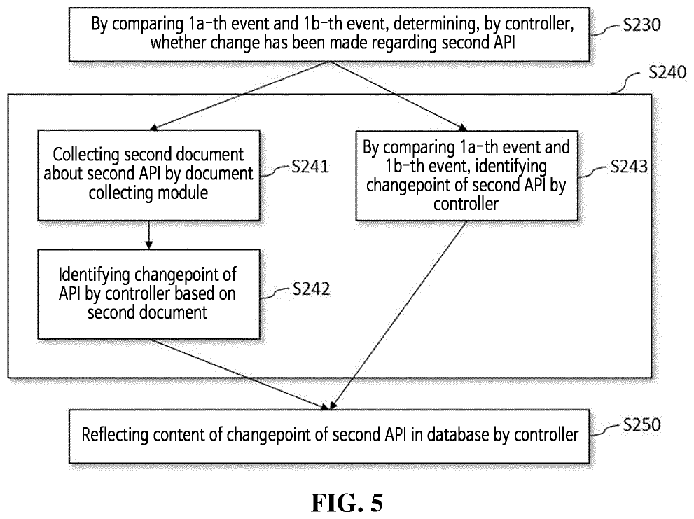

In operation S230, the controller 34 determines whether any change has been made regarding the second API by comparing the 1a event and the 1b event. Here, the controller 34 only determines whether any change has been made, and a detailed change point may be identified by the document collecting module 31 or the event collecting module 32. Details thereof will be described with reference to FIG. 5.

In operation S240, the controller 34 identifies a change point of the second API in response to a determination that a change has been made regarding the second API in operation S230. Here, even if there is no change point of the second API, the collected event information may be reflected in the database 33.

In operation S250, the controller 34 reflects the content of the change point of the second API in the database 33. The operation S250 may be different from the operation S150 only in terms of subject, but may be substantially identical to the operation S150 in terms of other details.

The content of a change point may include information on an API, a text document, a URL, content of sentences before and after a change, sentence composition, data, a content of deleted data, and metadata.

FIG. 5 is a flowchart illustrating a method for determining a change point in a case where the controller 34 determines whether any change has been made regarding an API by comparing the 1a event and the 1b event to according to an embodiment of the present disclosure.

After the operation S230 of identifying a change point of the second API, the controller 34 may performs different operations depending on whether the change point of the second API is identified based on a document or by comparing events. Here, the execution point in time may be performed at the same point in time, a predetermined cycle, and a time interval.

When the change point of the second API is identified based on the document, operations S241 and S242 are performed.

In operation S241, the document collecting module 31 collects a document about the second API. Here, the controller 34 may collect the document based on information on the second API stored in the database 33.

In operation S242, the controller 34 identifies the change point of the second API based on the second document. Here, if the change point of the second API is not identified in the second document, the controller may repeatedly collect the second document in operation S241 at a predetermined cycle and time interval.

When the change point of the second API is identified by comparing the events, operation S243 is performed.

In operation S243, the controller 34 identifies the change point of the second API by comparing the 1a event with the 1b event. Here, by comparing the 1a event with the 1b event, the controller 34 may determine an event update, an account activity, a task to be performed, resource use, a time of occurrence, and whether it is downloaded throughout the server 10. In addition, comparing the 1a event with the 1b event may include not just comparing events at different points in time, but also comparing event information previously stored in the database 33.

The event collected to determine the change point in operation S243 may be collected based on the change point identified in operation S242. In addition, the document collected to determine the change point in operation S241 may be collected based on the change point identified in operation S243.

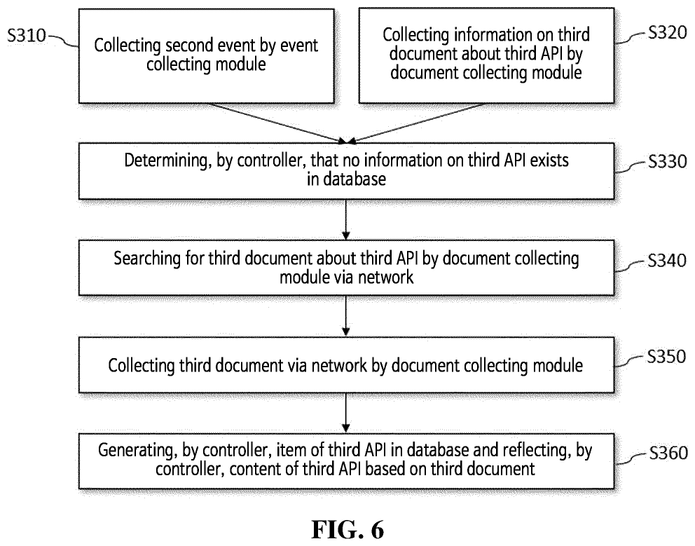

FIG. 6 is a flowchart for detecting that a new API is created according to an embodiment of the present disclosure.

In the method of detecting that a new API is created, the creation of the new API may be detected by the event collecting module 32 upon receiving an event generated by the new API or by the document collecting module 31 upon collecting a document about the new API. Both of the above methods may be performed, or only one of the two methods may be performed according to a circumstance.

Operation S310 relates to how creation of a new API is detected by the event collecting module 32 upon receiving an event generated by the new API.

In operation S310, the event collecting module 32 may collect a second event about a third API.

Operation S320 relates to how creation of a new API is detected through the document collecting module 31 upon collecting a document about the new API.

In operation S320, the document collecting module 31 may collect information on a third document about the third API. Here, the operations S310 and S320 may be performed simultaneously.

In operation S330, the controller 34 may determine that there is no information on the third API based on the database 33. Here, the database 33 may include information on the API based on information previously collected by the document collecting module 31 and the event collecting module 32. Based on the information collected in operation S310 or operation S320, the controller 34 determines whether information on the identified third API is present in the database 33. If there is no information about the third API in the database 33, the controller 34 may determine that the third API is a new API not previously managed in the database 33.

In operation S340, the document collecting module 31 may search for a third document about the third API via the network. This is to collect the third document on the third API when it is determined that the third API is a new API, thereby managing information on the third API in the database 33.

Here, even when it is determined that the third API is a new API in operation S330, when the document collecting module 31 may fail to search for the third document corresponding to the third API in the document server 20. This is because even if the second event generated by the third API is detected in operation S310, a document about the third API may not yet be created in the document server 20. In this case, the document collecting module 31 may perform the operation S340 according to a predetermined cycle and time interval so as to perform a re-search for the third document. As described above, when a new API is created and an event generated thereby is detected, there may be a case where a document about the new API is created and provided to the document server 20 after a predetermined time elapses. According to the above-described method, if a re-search is repeatedly performed several times according to the predetermined cycle and time interval, a document about a new API may be searched.

Searching for the third document about the third API by the document collecting module 31 may be performed in various ways. For example, the document collecting module 31 may review a document list of the document server 20 to determine whether a third document item about the third API to be searched is present in the list. In addition, as another example, the document collecting module 31 may create path information on a path where the third document is expected to be provided, based on basic information such as a name of the third API, and may attempt to access to the corresponding path information.

A specific method for the document collecting module 31 to search for the third document about the third API may be determined differently by how the document collection module 31 manages or provides a database that manages documents about APIs.

In operation S350, the document collecting module 31 may collect the third document searched through the network. The document collecting module 31 may collect and store the third document itself, or extract and identify only a necessary part from the third document.

In operation S360, the controller 34 may create an item of the third API in the database 33, and reflect a content of the third API based on the third document. Here, the item that the controller 34 creates in the database 33 may be created according to a category to which a corresponding API belongs or by a predetermined criterion. For example, when the document server 20 newly creates or deletes a policy for an API, an API item or classification corresponding to the new or deleted policy may be converted into an updated version and stored.

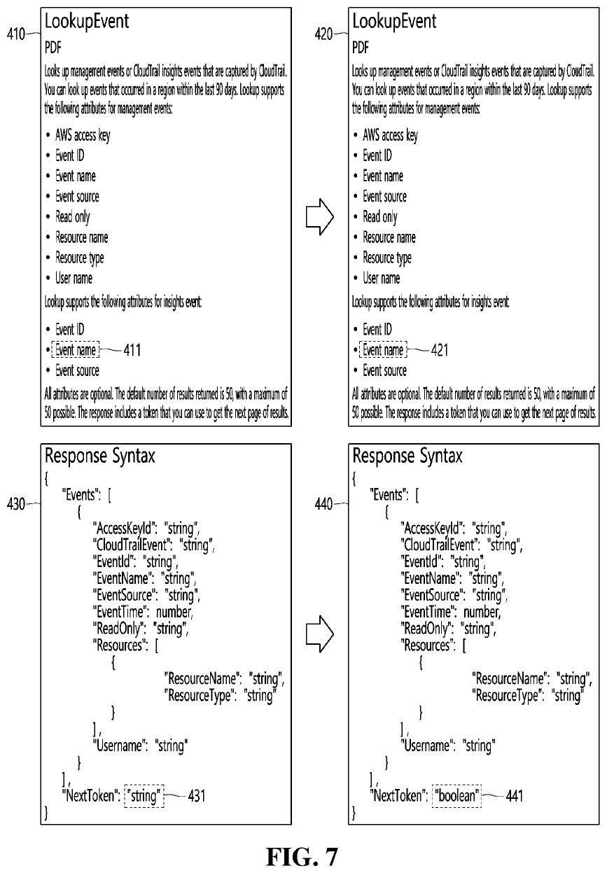

FIG. 7 is an exemplary screen for explaining a method of comparing documents provided from the document server 20 according to an embodiment of the present disclosure.

Referring to FIG. 7, the document collecting module 31 may collect a document about an API named “LookupEvents” from the document server 20 at a first point in time. The document collected at the first point in time may be referred to as a 1a document. The 1a document may include description information 410 of the corresponding API and description information 430 of a response syntax of the corresponding API.

Then, the document collecting module 31 may collect documents about a API named “LookupEvents”, which is identical to the above described API, from the document server 20 at a second point in time later than the first point in time. A document collected at the second point in time may be referred to as a 1b document. The document 1b may include description information 420 on the corresponding API and description information 440 on a response syntax of the corresponding API.

The controller 34 may identify a change point in the description information 410 on the corresponding API in the 1a document and in the description information 420 of the corresponding API in the 1b document by using the above-described NLP-based artificial intelligence model. Specifically, as shown in FIG. 7, the information 410 describes the name of one of attributes related to the API as “Event_name”. However, the information 420 describes the name of the corresponding attribute as “Event_name”. The controller 34 may determine such a change point and determine a specific change.

In addition, by comparing description information 430 on the response syntax of the 1a document and description information 440 on the response syntax of the 1b document, the controller 34 may identify that “NetToken” has changed from a first data type 431 to a second data type 441.

Based on the identified change point, the controller 34 may change the information on the API stored in the database 33 according to a changed policy. For example, a method of expressing “NextToken” in the database 33 may be change from String, which is the existing first data type 431, to Boolean, which is the second data type 441.

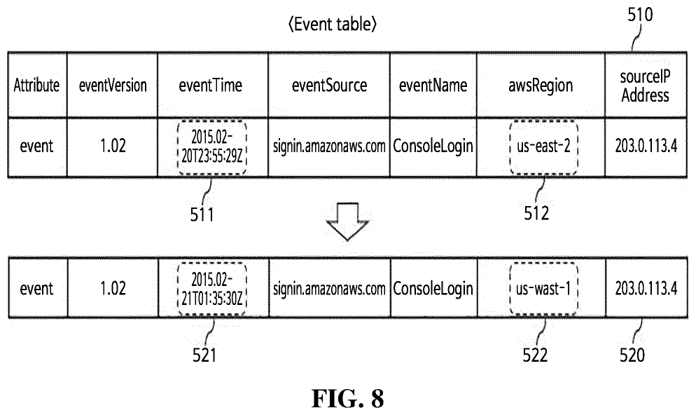

FIG. 8 is an exemplary screen for explaining a method for the controller 34 to compare events collected by the event collecting module 32 according to an embodiment of the present disclosure.

The event collecting module 31 may access the event recorder to collect event information. Here, the event information may be in the form of a first event table 510.

In order to identify an event change point, the controller 34 may collect a second event table 520 at a point in time later than a point in time at which the first event table 510 is collected.

The controller 34 may identify a change point by comparing the collected first event table 510 and the second event table 520, and may reflect the identified change point in the database 33. For example, the controller 34 may searches the database 33 for Consolelogin, which is an event corresponding to the first event table 510. In this case, if there is no information corresponding to Consolelogin, the controller 34 may create a Consolelogin item and reflect the Consolelogin item in the first event table 510. In addition, by comparing the first event table 510 and the second event table 520, the controller 34 may modify a first event time 521 to a second event time 511 and a first region 512 to a second region 522 in the database 33.

In the method of analyzing a change point of a cloud API according to the present disclosure, it is possible to easily identify and manage a change point of an API in a cloud.

In addition, in the method of analyzing a change point of a cloud API according to the present disclosure, it is possible to provide a notification so that a server manager can smoothly manage a server when importance of an AIP change point in a cloud satisfies a notification threshold.

Technical features disclosed in each embodiment of the present disclosure are not limited to a corresponding embodiment, and unless incompatible with each other, the technical features disclosed in each embodiment may be combined and applied to other embodiments.

Thus, in each embodiment, each technical feature is mainly described, but the technical features may be combined and applied to each other unless incompatible with each other.

Although representative embodiments of the present disclosure have been described in detail above, it is apparent to those of ordinary skill in the art that various changes can be made without departing from the scope of the present disclosure. Therefore, the scope of the present disclosure is not limited to the embodiments disclosed herein, and it should be defined by the appended claims and also equivalents to which such claims are entitled.

What is claimed is:

1. A method of analyzing a change in an API in a cloud by a server,
wherein the server comprises:
a document collecting module configured to collect a document via a network;
an event collecting module configured to collect information on a user's events;
a database configured to store information on APIs; and
a controller configured to control the document collecting module and the event collecting module,
wherein the method comprises:
collecting, by the document collecting module, a 1a document at a first point in time via the network, wherein the 1a document is a document about a first API collected at the first point in time;
collecting, by the document collecting module, a 1b document at a second point in time via the network, wherein the 1b document is a document about a first API collected at the second point in time;
determining, by the controller, whether any change has been made regarding the first API by comparing the 1a document and the 1b document;
in response to a determination that any change has been made regarding the first API, identifying a change point of the first AP by the controller;
reflecting, by the controller, information on the change point of the first API in the database;
collecting, by the event collecting module, a 1a event at a third point in time, wherein the 1a event is an event about a second API collected at the third point in time;
collecting, by the event collecting module, a 1b event at a fourth point in time, wherein the 1b event is an event about the second API collected at the fourth point in time;
determining, by the controller, whether any change has been made regarding the second API by comparing the 1a event and the 1b event;
in response to a determination that any change has been made regarding the second API, identifying a change point of the second API by the controller; and
reflecting, by the controller, a content of the change point of the second API in the database.

2. The method of claim 1, wherein the method of analyzing a change in an API in a cloud is provided as a Software-as-a-Service (SAAS) method.

3. The method of claim 1, wherein the identifying of the change point of the second API comprises:
collecting, by the document collecting module, a second document about the second API; and
identifying, by the controller, the change point of the second API based on the second document.

4. The method of claim 1, wherein in the identifying of the change point of the second API, the controller compares the 1a event and the 1b event to identify the change point of the second API.

5. The method of claim 1, further comprising:
collecting, by the event collecting module, a second event, wherein the second event is an event about a third API;
determining, by the controller, that there is no information on the third API in the database;
searching, by the document collecting module, for a third document about the third API via the network;
collecting, by the document collecting module, the third document via the network;
generating, by the controller, an item of the third API in the database and reflecting, by the controller, a content of the third API based on the third document.

6. The method of claim 1, further comprising:
collecting, by the document collecting module, information on a third document about a third API;
determining, by the controller, that there is no information on the third API in the database;
searching, by the document collecting module, for a third document about the third API via the network;
collecting, by the document collecting module, the third document via the network; and
generating, by the controller, an item of the third API in the database and reflecting, by the controller, a content of the third API based on the third document.

7. The method of claim 1, further comprising:
determining, by the controller, importance of any one of a change point of the first API and a change point of the second API;
determining, by the controller, whether the importance satisfies a notification threshold; and
providing, by the controller, a notification of any one of the change point of the first API and the change point of the second API to a manager terminal.

8. The method of claim 1,
wherein the database stores a plurality of classification groups in which a plurality of APIs are classified by a predetermined criteria, and
wherein the method further comprises determining, by the controller, at least one of a cycle and a time interval between the first point in time and the second point in time based on a classification group to which the first API belongs among the plurality of classification groups.
